(19) United States
(12) Patent Application Publication
(10) Pub. No.: US 2009/0138493 A1
(43) Pub. Date: May 28, 2009

(54) METHOD AND SYSTEM FOR MEDIA TRANSFORMATION

(75) Inventors: Chris Kalaboukis, Los Gatos, CA (US); Roberto Fisher, Santa Monica, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/944,442

(22) Filed: Nov. 22, 2007

(51) Int. Cl. G06F 5/00

(52) U.S. Cl. 707/101; 707/E17.006

(57) ABSTRACT

Systems and methods have been developed for transforming the format of media objects. More specifically, systems and methods have been developed for transforming the format of media objects associated with a user media locker.

### BACKGROUND

Increasingly the Internet and other networks (e.g., wired and wireless networks) are utilized to transmit content in the form of media objects (e.g., video, audio, etc.) between users and content providers or distributors. Users may consume (e.g., watch, listen to, etc.) or otherwise utilize this content in various locations and with various media applications (e.g., client devices).

### SUMMARY

Systems and methods have been developed for transforming the format of media objects. More specifically, systems and methods have been developed for transforming the format of media objects associated with a user media repository (e.g., a “media locker”).

In one embodiment (which embodiment is intended to be illustrative and not restrictive), a method for media transformation is provided. The method includes receiving a request to consume a media object accessible from a user media repository, the media object having a first format and the request identifying a media application for consuming the media object. The method further includes identifying a preferred format for use by the media application. The method yet further includes, if the first format is not the preferred format, transforming the media object from the first format into the preferred format. The method still further includes delivering the media object in the preferred format to the media application.

In one aspect of the method wherein the request includes information identifying the preferred format, the step of identifying a preferred format for use by the media application includes processing the information identifying the preferred format. In another aspect of the method, the step of identifying a preferred format for use by the media application includes selecting the preferred format from a plurality of formats compatible with the media application. In yet another aspect of the method, the step of identifying a preferred format for use by the media application includes requesting information from the media application to identify the preferred format, and receiving information identifying the preferred format from the media application. In still another aspect of the method, the step of identifying a preferred format for use by the media application includes identifying a preferred format based upon a delivery characteristic for performing the step of delivering the media object in the preferred format to the media application. In another aspect of the method, the media object or a license to the media object is stored within the user media repository. In yet another aspect of the method, the media application is a client computing device. In still another aspect of the method, the media object accessible to the user media repository is accessed via the Internet. In another aspect of the method, the first format and the preferred format share a common file type with at least one differing consumption characteristic. In yet another aspect of the method, the at least one consumption characteristic is a display characteristic, delivery characteristic, or compression characteristic. In still another aspect, the method includes confirming the user has a license to perform the step of transforming the media object from the first format into the preferred format. In another aspect of the method, the step of transforming the media object from the first format into the preferred format includes transforming the media object from the first format into the preferred format. In yet another aspect of the method, the media object is transcoded from an analog format into a digital format or from a digital format into an analog format. In still another aspect of the method, transcoding includes reformatting the media object from a first file format into a second file format. In another aspect of the method, the step of transforming the media object from the first format into the preferred format includes transforming the media object from a video format into an audio format or from an audio format into a video format. In yet another aspect of the method, the media object includes video data and the step of transforming the media object from the first format into the preferred format includes changing the video data resolution. In another aspect of the method, transforming the media object from the first format into the preferred format further includes identifying a property of the first format that augments the preferred format and, based upon the identified property, augmenting the preferred format of the media object. In yet another aspect, wherein the first format is an audio file, the preferred format is a video file, the property is a keyword, the method comprises augmenting the preferred format by adding video information based upon the keyword. In another aspect, wherein the first format is a video file, the preferred format is an audio file, the property is an image, the method comprises augmenting the preferred format by adding audio information based upon the image.

In still another aspect, the method includes searching one or more servers for the media object. In another aspect, the method includes receiving compensation from the user or a third party for performing the step of delivering the media object in the preferred format to the media application. In yet another aspect of the method, the compensation is non-monetary. In still another aspect, the method includes receiving compensation from the user or a third party for performing the step of transforming the media object from the first format into the preferred format. In another aspect of the method, the compensation is non-monetary.

These and various other features as well as advantages will be apparent from a reading of the following detailed description and a review of the associated drawings. Additional features are set forth in the description which follows, and in part will be apparent from the description, or may be learned by practice of the described embodiments. While it is to be understood that both the foregoing general description and the following detailed description are exemplary and explanatory, the benefits and features will be realized and attained by the structure particularly pointed out in the written description and claims hereof as well as the appended drawings.

### BRIEF DESCRIPTION OF THE DRAWINGS

The following drawing figures, which form a part of this application, are illustrative of embodiments systems and methods described below and are not meant to limit the scope of the invention in any manner, which scope shall be based on the claims appended hereto.

FIG. 1 illustrates an embodiment of a system for transforming media objects.

FIG. 2 illustrates another embodiment of a system for transforming media objects.

FIG. 3 illustrates an embodiment of a method for transforming media objects.

FIG. 4 illustrates another embodiment of a method for transforming media objects.

FIG. 5 illustrates yet another embodiment of a method for transforming media objects.

### DETAILED DESCRIPTION

The following detailed description is intended to convey a thorough understanding of the embodiments described by providing a number of specific embodiments and details involving systems and methods for transforming media objects. It should be appreciated, however, that the claims appended hereto are not limited to these specific embodiments and details, which are exemplary only. It is further understood that one possessing ordinary skill in the art, in light of known systems and methods, would appreciate the applicability of this disclosure for its intended purposes and benefits in any number of alternative embodiments, depending upon specific design and other needs.

As set forth in this disclosure, including the claims and figures appended hereto, the term media object refers to an individual item of media having characteristics that can be objectively analyzed. One skilled in the art will recognize that a media object may take many forms. For example, a media object may be comprised of audio, video, imagery, text, or other data in the form of electronic files. Typically, a media object may be consumed (i.e., played, displayed or rendered) in a variety of ways. For example, a media object may be comprised of an audio file (e.g., an MP3 audio file) that may be consumed (e.g., played) using audio playback hardware and/or software. Similarly, a media object comprised of a compressed video file may be consumed (e.g., decompressed and played) using a hardware and/or software video decoder and playback engine. Depending on the embodiment, a media object may be delivered (e.g., streamed or otherwise transmitted to an application, device, etc.) for consumption, for example, at a rendering device. In some cases, media objects may be encapsulated within other media objects. For example, a media object comprising a portion of text (e.g., a movie title) may be embedded within another media object (e.g., a streaming MPEG-2 video file). One skilled in the art will recognize that media objects may take many forms that are within the scope of this disclosure.

As further set forth in this disclosure, including the claims and figures appended hereto, the term format is used interchangeably to refer to the format of the media object container or data structure (e.g., a file format such as a .jpeg, .mp3, or .avi file) or the format of the content that is embodied within the media object (e.g., video content in a high-definition format that is down converted to a lower resolution format, or a color picture formatted as a black-and-white picture, or video content that is transformed from a video format into an audio format). Thus, changing the format of a media object may include, but is not limited to, modifying or otherwise manipulating a media object file or the content contained within a media object file.

Additionally, as further set forth in this disclosure, including the claims and figures appended hereto, consumption of media objects may take place on a variety of computing devices and/or media applications (i.e., software). For example, computing devices may include, but are not limited to, personal computers, mobile computers (i.e., laptops or mobile phones), televisions, set-top-boxes, and personal digital assistants. Typically, computing devices will include a processor and memory for storing data and software. Computing devices may include operating system software that allow execution of software programs and manipulation of data. As set forth herein, computing devices may communicate using many types of networks, including but not limited to wired and wireless data connections (e.g., computing devices may interconnect via wired connections to the Internet). One skilled in the art will recognize that computing devices and networks may take many forms that are within the scope of this disclosure.

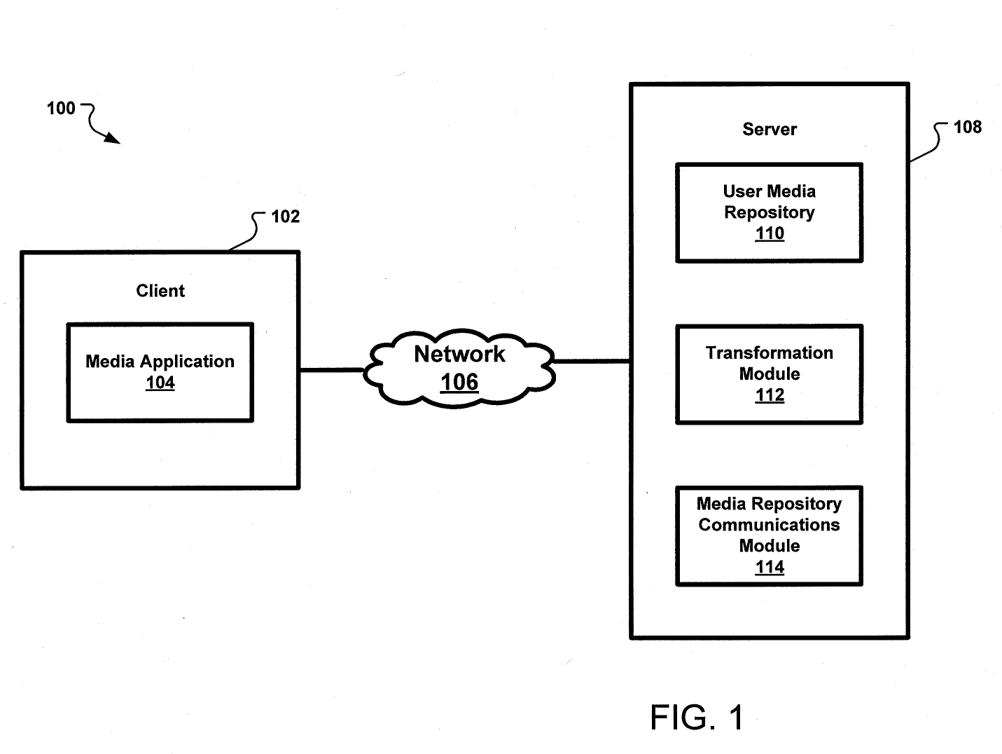

FIG. 1 illustrates an embodiment of a system 100 for transforming media objects. The system 100 is a computing architecture that comprises a client 102 computing device and server 108 computing device that are connected via a network 106. The client 102 may be comprised of a variety of computing devices, including, but not limited to, personal computers, personal digital assistants, telephones, wireless devices, gaming systems, and other devices. For example, the client 102 may be comprised of a personal computer that includes a processor and memory, upon which software may be executed. In an embodiment, a media application 104 comprising instructions may be executed on a processor of the client 102. A media application 104 may itself be comprised of instructions and other data in the form of software for execution on the client device 102. For example, a media application 104 may be comprised of one or more programs, such as a web browser, a media playback application, and other software for consuming media objects. One skilled in the art will recognize that many types of media applications 104 may exist that are within the scope of this disclosure. The client 102 computing device may be connected to the server 108 via a network 106, such as the internet. A network may be comprised of one or more computing device (e.g., servers and other computing devices) that are interconnected wirelessly or in wired configurations. One skilled in the art will recognize that many types of networks that exist that are within the scope of this disclosure. Typically, a network 106 is comprised of computers and associated devices that are connected by communications facilities. A network 106 may involve permanent connections, such as cables or temporary connections made through telephone or other communications links. A network 106 may be as small as a local area network (LAN) and may be comprised of a few computers, printers, and/or other devices, or it may also be comprised of small and large computers distributed over a vast geographic area (e.g., a wide-area network (WAN)). A server 108 may be comprised of one or more computers that are interconnected to one or more client 102 devices via a network 106. A server 108 may be comprised of one or more computers and/or programs that respond to commands from a client 102. Typically, for example, a file server may contain an archive of data or program files. When a client 102 submits a request for a file, the server 108 may transfer a copy of the file to the client 102. A server 108 may include or be connected to one or more hard disks and/or other storage devices. One skilled in the art will recognize that a server 108 may also be comprised of computing devices that may not include certain storage devices. Typically, a server 108 may serve (e.g., stream and/or otherwise deliver) files to a client 102 via a network 106. Files and other media objects may reside within a user media repository 110. A user media repository 110 may itself be comprised of one or more computing devices for recording computer data in permanent, semi-permanent, or temporary form. For example, a user media repository 110 may be comprised of random access memory, read-only memory, and other types of memory. Alternatively, or in addition, a server 108 may also be comprised of various types of physical storage media. For example, a user media repository 110 may be comprised of devices such as hard disks, tape and optical disks, and/or other types of physical storage media on which data bits are written and stored.

In one embodiment, a transformation module 112 is provided for transforming the format of a media object from a first format into a second format. The transformation module 112 may be comprised of hardware and/or software for transforming media objects. For example, the transformation module 112 may be comprised of a hardware decoder that decodes a media object in the form of a video file into a video file of a different format. Following this example, a compressed video file (e.g., an .mpeg file) may be decoded and re-formatted into a file with a different compression scheme (e.g., a Windows Media video file). The transformation module 112 may also be comprised of software that transforms media objects from a first format into a second format. For example, the transformation module 112 may transform a media object in the form of an audio file with a certain compression ratio or bit rate (e.g., 128 kbit/s) to an audio file with a different compression ratio or bit rate (e.g., 320 kbit/s). In the transformation module 112, a media object may be translated, trans-coded, or otherwise manipulated. By transforming the media object within transformation module 112, the media object may then be consumed in various environments and by various devices. In one embodiment, a server 108 may further comprise a media repository communications module 114. The media repository communications module 114 may itself be comprised of hardware and/or software for delivering the media object to a client 102 and/or receiving instructions from the client 102 or another computing device for manipulating the media object within the server 108. For example, as discussed below, a media repository communications module 114 may include, but is not limited to including, one or more servers that may be distributed or that may operate in parallel.

In one embodiment of system 100, a media application 104 of a client 102 communicates via network 106 to the server 108. The media application 104 may request a media object stored within a user's media repository 110. The media application 104 may also request a media object in a certain format and/or the server 108 may interpret from the request what format of media object is being requested by the media application 104 and the client 102. In one embodiment, a media object is then located within a user's media repository 110, whereupon if the media object is not within the requested format, a transformation module 112 may transform the media object into a different format, as may be requested by media application 104 and client 102. The new format includes, but is not limited to, providing a media object with a different file type than the media object stored in the user's media repository 110. Transformation of the media object may also include transforming a media object from a video file format into an audio file format, or vice versa. In this example, transformation of a video file into an audio file may be augmented by adding audio information to the audio file that describes or otherwise relates to video information (e.g., images, etc.) from the video file. Similarly, transformation of an audio file into a video file may be augmented by adding video information that describes or otherwise relates to audio information (e.g., keywords, music, etc.) from the audio file. One skilled in the art will also recognize that many other ways of reformatting media objects are possible and within the scope of this disclosure, including, but not limited to, reformatting display, rendering, or consumption characteristics of media objects (e.g., display resolution, compression ratios, transmission properties, etc.). Transformation of media objects from one format into another format may be automatic or may be manual. In one embodiment, a server 108 may transform a media object such that the media object is transmitted via media repository communications module 114 and network 106 to the media application 104 of client 102. The media object may then be consumed in its new format by the media application 104 by a user viewing or otherwise using media application 104. One skilled in the art will recognize that many forms of consumption are within the scope of this disclosure, including, but not limited to, playback of media objects that may be played, display of media objects that may be displayed, and/or rendering of media objects that may be rendered. For example, a media object that comprises a video file may be played back by a media application 104, such as Windows Media Player or other software designed for playing back media objects in the form of video. As another example, a media object in the form of a compressed audio file may be rendered by software that interprets instructions encoded using an MP3 codec.

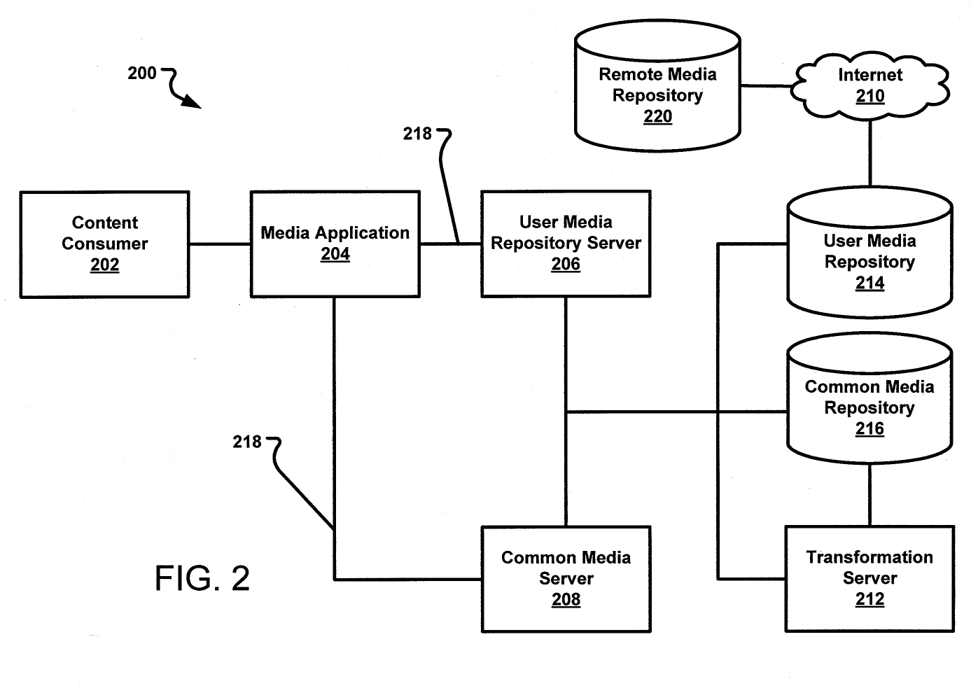

FIG. 2 illustrates another embodiment of a system 200 for transforming media objects. The system 200 is another computing architecture for transforming media objects. In the system 200, a content consumer 202 (i.e., a user) requests, using a media application 204, a media object from the user's media repository 214. The request is received from the media application 204 by a user media repository server 206 via an internet, intranet, or other network connection 218. The request may or may not identify the format for consumption of the media object. Additionally, or in the alternative, the media application 204 may request a media object from the media repository 214 without specifying the format for transmission of the media object to the media application 204. In one embodiment, the user media repository server 206 receives the request from media application 204 and communicates that request to a common media server 208. The common media server 208 may then determine whether the media object that is requested resides in the user's media repository 214, whether the media object additionally, or in the alternative, resides on or is connected to a network, such as Internet 210, or whether the media object resides at some other location (e.g., remote media repository 220). In one embodiment, a common media server 208 that is unable to locate a media object within the media repository 214 may determine whether the media object resides in a common media repository 216. A common media repository 216 may be comprised of one or more storage devices for storing media objects that are accessible to, but not yet part of the content consumer's 202 or user's media repository 214. For example, while a media object of a certain format (e.g., a media object in the form of a standard definition video file) may reside in a user's media repository 214. A common media repository 216 may include a high-definition version of the same media object in the form of a high-definition video file. A transformation server 212 may then be utilized by common media server 208 to transform the media object in the form of a standard definition video file into a format that may be consumed at media application 204. The common media server 208 may also transmit the originally formatted media object to the media application 204. In another embodiment, user media repository server 206 may receive a request from the media application 204 and, based upon the request, determine the format for delivering and/or consuming the media object at the media application 204. In yet another embodiment, the common media server 208 may determine what format is required for consumption of the media object at the media application 204. As described previously, media objects may be consumed in a variety of different formats, including, but not limited to, formats that alter the display characteristics, compression ratios, transmission properties, etc.

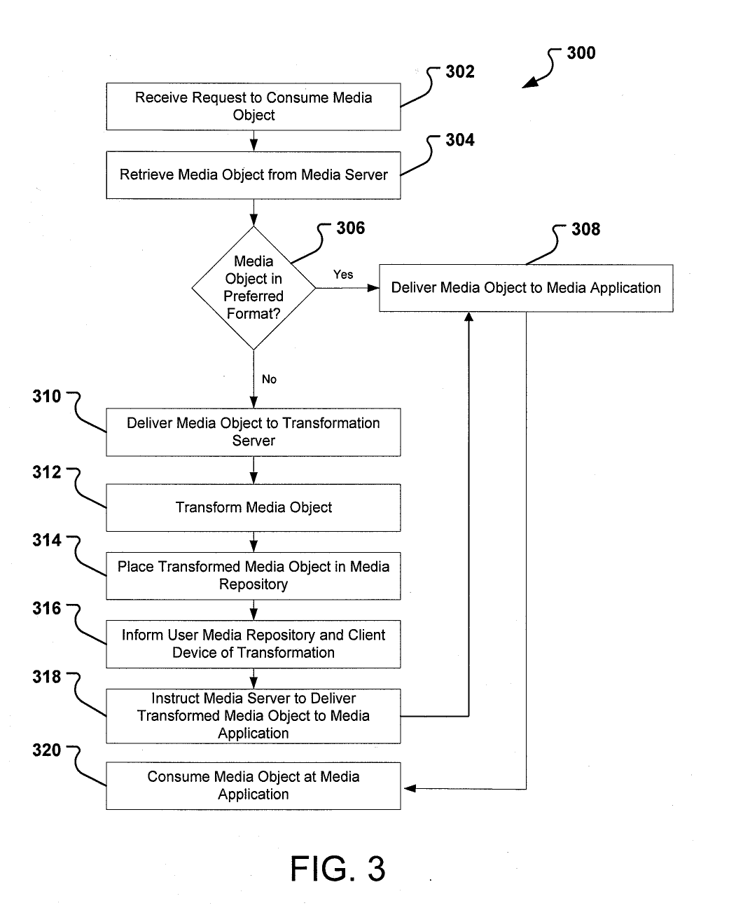

FIG. 3 illustrates an embodiment of a method 300 for transforming media objects. In the method 300, a media object is accessible from or stored within a user's media repository (e.g., a user's “media locker”). In one embodiment, a user may utilize a media application 204 (e.g., hardware and/or software) that communicates a request from the user to consume the media object. The request is received in a receiving operation 302. For example, a request may be transmitted by a media application 204 and received by a user media repository server 206. The request may or may not identify the media application 204 that is requesting consumption of the media object. The request may or may not also identify characteristics for how the media object will be consumed by and/or delivered to the media application 204. In one embodiment, the common media server 208 retrieves the media object in a retrieving operation 304. For example, a user media repository server 206 may deliver the request to a common media server 208 which retrieves the media object from a storage location such as a user's media repository 214 or a common media repository 216. Retrieving operation 304 may include, but is not limited to, directly accessing, copying or otherwise placing the media object into memory such that it may be manipulated and/or delivered to a media application 204. In one embodiment, the method 300 further comprises identifying whether the media object that is retrieved is in a preferred format (e.g., a format requested or supported by the media application 204, a delivery format, etc.) in identifying operation 306. For example, identifying operation 306 may include determining whether a media object includes video content having some type of display resolution, compression ratio, presentation format (e.g., letterbox or 4:3 presentation formats) or other characteristics. As another example, identifying operation 306 may include determining whether a media object includes video content having a certain audio or textual sub-track (e.g., Spanish-language audio track). As yet another example, identifying operation 306 may include determining whether a media object includes a picture that is compressed or uncompressed according to some delivery (i.e., transmission) requirements. Following this example, a media object may be transformed such that it may be delivered to media applications 204 having slower and faster access to a common media server 208. In one embodiment, where a media object is identified to be in a preferred format, the method 300 may then include delivering the media object in a delivering operation 308. Delivering operation 308 may include, but is not limited to, streaming or otherwise transmitting a portion of or the entire media object to a media application 204. In another embodiment, where the media object is not determined to be in an preferred format, the method 300 may further comprise delivering the media object to a transformation server 212 in a delivery operation 310. For example, a delivery operation 310 may include providing instructions from a user media repository server 206 to a common media server 208 that instruct the user media repository server 206 to transform the media object utilizing a transformation server 212. In the method 300, the media object may then be transformed in transforming operation 312. One skilled in the art will recognize that transformation of media objects may include, but is not limited to, transcoding, translation, and re-formatting the media object. One skilled in the art will also recognize that transformation of the media object may include, but is not limited to, transformation of the content (i.e., data or information) within a media object and/or transformation of the media object file or other data structure that contains the content. For example, transforming operation 312 may include upconverting standard-definition video content to high-definition video content. As another example, transforming operation 312 may include transcoding from a Window Media File (WMF) video file format into an Audio-Video Interleaved (AVI) file format. In one embodiment, method 300 may further comprise placing a transformed media object within a common media repository 216 and/or user media repository 214 in a placing operation 314. In another embodiment, a user media repository server 206 or another computing device may inform 316 the media application 204 and/or the user media repository 214 that the media object was transformed. In the method 300, the media object is delivered to a media application 204 in delivery operation 318. Delivery 318 of a media object to the media application 204 may include, but is not limited to, streaming, sending or otherwise transmitting the media object to the media application 204. In still yet another embodiment, the method 300 may further comprise consuming 320 the media object at the media application 204. For example, consumption of the media object may include, but is not limited to, playing, displaying or otherwise rendering the media object. As another example, and as discussed earlier, transforming operation 312 may also include transforming a media object from a video file format into an audio file format, or vice versa. In this example, transformation of a video file into an audio file may be augmented by adding audio information to the audio file that describes or otherwise relates to video information (e.g., images, etc.) from the video file. Similarly, transformation of an audio file into a video file may be augmented by adding video information that describes or otherwise relates to audio information (e.g., keywords, music, etc.) from the audio file.

As a further illustration of the method 300, a user attending an Avril Lavigne concert may use her cellphone to videotape Avril singing the song, Girlfriend. The user may then save the video on the phone, uploaded it to her media locker on a server, and delete the video from the phone. Later on, while she is driving home and wishes to listen to the song on her car stereo, she uses her cellphone to access the video, and asks for it to be played back over her cellphone, audio only. In this example, the user may plug her cellphone into an FM transmitter in order to send the signal from her phone to the car stereo. Meanwhile, the media locker may send the video to the transformation server 212 to be stripped of its video feed, and the audio to be enhanced as much as possible for delivery to the user's car stereo.

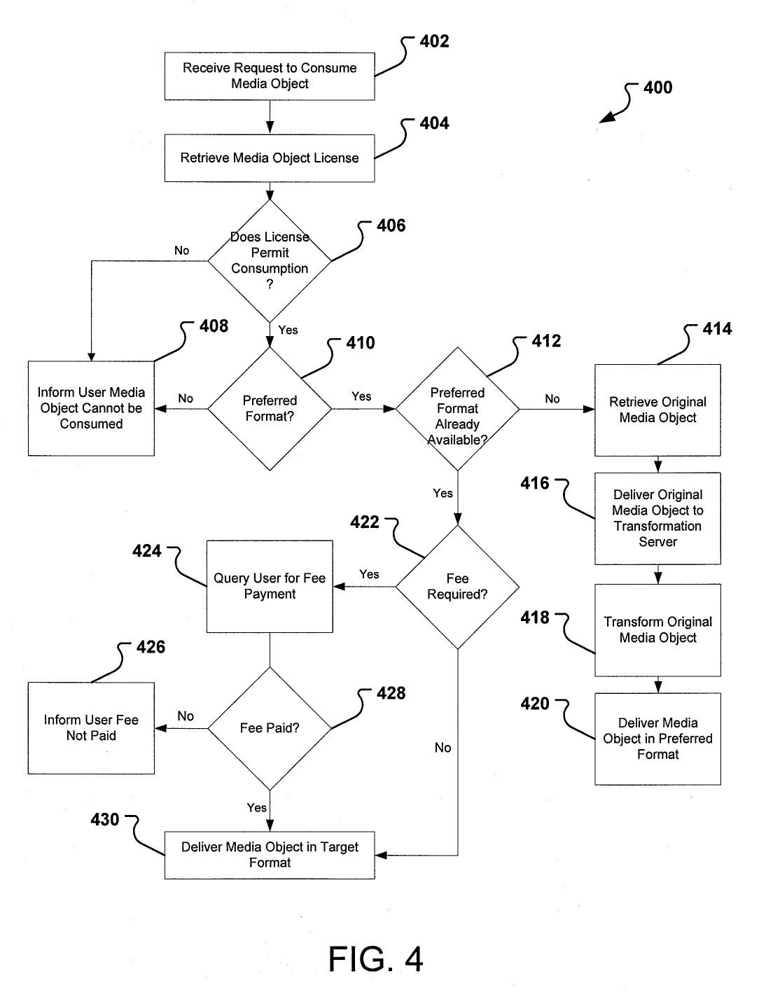

FIG. 4 illustrates another embodiment of a method 400 for transforming media objects. In the method 400, a request to consume a media object is received in a receiving operation 402. In response to the request, a license corresponding to the media object is retrieved in retrieving operation 404. For example, a media object license may be stored within a user's media locker such that the license conditions, limits or otherwise restricts how the media object may be consumed, distributed or otherwise manipulated. The method 400 then identifies whether the media object license permits consumption of the media object in an identifying license terms operation 406. For example, the license corresponding to a media object may restrict the format for consuming the media object at a media application 204 (e.g., limiting the presentation window, resolution, trick-modes or number of plays of a media object with video content). As another example, the license corresponding to the media object may restrict consumption to certain media applications 204 (e.g., the media object may or may not be consumed on a wireless device). Following this example, in a notification operation 408, a user (or the user's media application 204) may be notified that the media object cannot be consumed in the manner requested during receiving operation 402. The method 400 may further comprise identifying in an identifying operation 410 whether the license permits consumption of the media object within a preferred format (e.g., as requested by a user or related to the type of media application 204). The method 400 may then further yet comprise identifying whether the preferred format of the media object is already available (e.g., stored within a common media repository 216) in an identifying operation 412. In one embodiment, a user fee may be required as determined in an identifying operation 422 and communicated to a user in a querying operation 424. Where a fee is required for consumption of the media object, a determining operation 428 may determine whether the fee was paid by the user and notify the user in an information operation 426 if the fee is unpaid. The method 400 may then comprise delivering the media object to the user in a delivering operation 430. Similar to the description set forth above regarding transformation of media objects, a media object that is not identified as being in a preferred format may be retrieved 414, delivered 416 to a transformation server 212 for transformation 418 and delivery 420 to a media application 204.

As yet a further illustration of the method 400, a user may buy a license to watch the Avril Lavigne video of the song Girlfriend. The license may restrict the user to watching the video on her High Definition television set. While the user is in her car and would like to hear the audio component of the video, she may log into her media locker from her cell phone and requests that the song be transformed for her car stereo via her cellphone. The media locker may inform her that for an extra 50 cents, she can get the audio track streamed to her phone as many times as she wants. If the user agrees, the media locker may proceeds to retrieve the audio-only lower quality version of the video and stream the lower quality audio-only version to the user's phone.

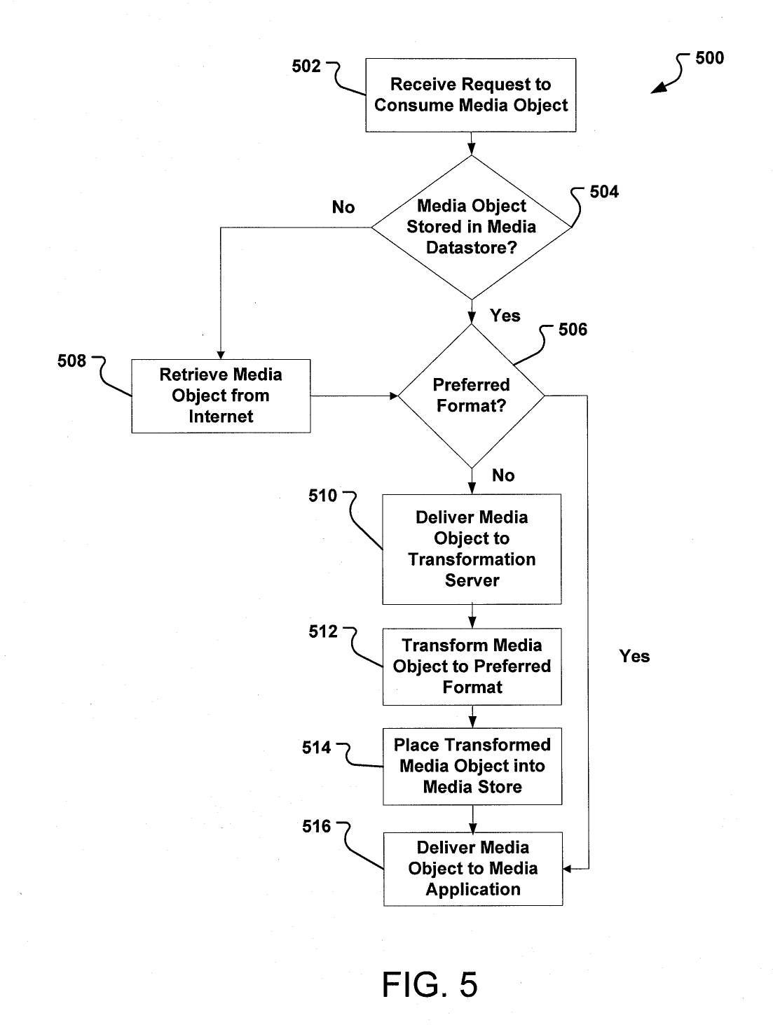

FIG. 5 illustrates yet another embodiment of a method 500 for transforming media objects. The method 500 comprises receiving a request to consume a media object in a receiving operation 502. In a determining operation 504, it is determined whether the media object is already contained within a common media repository 216. If the media object is not determined to be within the common media repository 216, the media object may be retrieved from a network location (e.g., the Internet) in a retrieving operation 508. In an identifying operation 506, the media object is identified to be within a preferred format. Where the media object is identified as being in the preferred format, the media object is then delivered to a media application 204 in delivering operation 516. If the media object is not within the preferred format, the media object is delivered to a transformation server 212 in delivering operation 510 where it is transformed into the preferred format in transforming operation 512. Once transformed in transforming operation 512, the media object is placed into the common media repository 216 in a placing operation 514 before it is then delivered in delivering operation 516.

In other embodiments, one or more of the above referenced methods may comprise a computer readable medium encoding or containing computer executable instructions for performing a method for displaying a web page element. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of this disclosure. For example, the media application may reside on a client 102, server 108, or some combination of the two. As another example, transformation of media objects may occur with or without intervention by a user of a client device or a client-side or server-side process.

Numerous other changes may be made which will readily suggest themselves to those skilled in the art and which are encompassed in the spirit of this disclosure and as defined in the appended claims.

What is claimed is:

1. A method comprising:
(a) receiving a request to consume a media object accessible from a user media repository, the media object having a first format and the request identifying a media application for consuming the media object;
(b) identifying a preferred format for use by the media application;
(c) if the first format is not the preferred format, transforming the media object from the first format into the preferred format; and
(d) delivering the media object in the preferred format to the media application.

2. The method of claim 1 wherein the request includes information identifying the preferred format and step (b) comprises:
processing the information identifying the preferred format.

3. The method of claim 1 wherein step (b) comprises:
selecting the preferred format from a plurality of formats compatible with the media application.

4. The method of claim 1 wherein step (b) comprises:
requesting information from the media application to identify the preferred format; and
receiving information identifying the preferred format from the media application.

5. The method of claim 1 wherein step (b) further comprises:
identifying a preferred format based upon a delivery characteristic for performing step (d).

6. The method of claim 1 wherein the media object or a license to the media object is stored within the user media repository.

7. The method of claim 1 wherein the media application is a client computing device.

8. The method of claim 1 wherein the media object accessible to the user media repository is accessed via the Internet.

9. The method of claim 1 wherein the first format and the preferred format share a common file type with at least one differing consumption characteristic.

10. The method of claim 9 wherein the at least one consumption characteristic is a display characteristic, delivery characteristic, or compression characteristic.

11. The method of claim 1 further comprising:
confirming the user has a license to perform step (c).

12. The method of claim 1 wherein step (c) comprises:
transcoding the media object from the first format into the preferred format.

13. The method of claim 12 wherein the media object is transcoded from an analog format into a digital format or from a digital format into an analog format.

14. The method of claim 12 wherein transcoding comprises:
reformatting the media object from a first file format into a second file format.

15. The method of claim 1 wherein step (c) comprises:
transforming the media object from a video format into an audio format or from an audio format into a video format.

16. The method of claim 1 wherein the media object includes video data and step (c) comprises:
changing the video data resolution.

17. The method of claim 1 wherein transforming the media object from the first format into the preferred format further comprises:
identifying a property of the first format that augments the preferred format; and
based upon the identified property, augmenting the preferred format of the media object.

18. The method of claim 17 wherein the first format is an audio file, the preferred format is a video file, the property is a keyword and augmenting the preferred format comprises:
adding video information based upon the keyword.

19. The method of claim 17 wherein the first format is a video file, the preferred format is an audio file, the property is an image and augmenting the preferred format comprises:
adding audio information based upon the image.

20. The method of claim 1 further comprising:
searching one or more servers for the media object.

21. The method of claim 1 further comprising:
receiving compensation from the user or a third party for performing step (d).

22. The method of claim 21 wherein the compensation is non-monetary.

23. The method of claim 1 further comprising:
receiving compensation from the user or a third party for performing step (c).

24. The method of claim 23 wherein the compensation is non-monetary.

25. A computer readable medium encoding or containing computer executable instructions for performing a method, the method comprising:
(a) receiving a request to consume a media object accessible from a user media repository, the media object having a first format and the request identifying a media application for consuming the media object;
(b) identifying a preferred format for use by the media application;
(c) if the first format is not the preferred format, transforming the media object from the first format into the preferred format; and
(d) delivering the media object in the preferred format to the media application.
